(19) United States
(12) Patent Application Publication
(10) Pub. No.: US 2007/0091429 A1
(43) Pub. Date: Apr. 26, 2007

(54) Tilting device and operation method thereof

(76) Inventors: Yang-Ho Moon, Ansan-si (KR); Chil-Sung Lee, Suwon-si (KR); Kyoung-Shin Park, Suwon-si (KR); Dong-Won Choi, Suwon-si (KR); Jae-Kyung Kim, Ansan-si (KR)

Correspondence Address: STANZIONE & KIM, LLP, 919 18TH STREET, N.W., SUITE 440, WASHINGTON, DC, 20006, US

(21) Appl. No.: 11/345,339

(22) Filed: Feb. 2, 2006

(30) Foreign Application Priority Data
Oct. 14, 2005 (KR) 2005-96769

(51) Int. Cl. G02B 23/00

(52) U.S. Cl. 359/431

(57) ABSTRACT

A tilting device and an operation method thereof are disclosed. The tilting device according to the invention comprises a mirror positioned on a light path which periodically tilts light, a mirror holder joined to the mirror which vibrates with the mirror, a holder support part supporting the mirror holder to allow vibration, and a driving part which provides driving power to the mirror holder, wherein the driving part forms a predetermined angle with the mirror holder and causes vibration about the intersecting first axis and second axis. Thus, the tilting device may not only provide a smooth and natural display but also reduce the number of digital micro-mirror pixels.

### CROSS-REFERENCE TO RELATED APPLICATIONS

This application claims the benefit of Korean Patent Application No. 2005-96769 filed with the Korea Industrial Property Office on Oct. 14, 2005, the disclosure of which is incorporated herein by reference.

### BACKGROUND OF THE INVENTION

1. Field of the Invention

The present invention relates to a tilting device and an operation method thereof.

2. Description of the Related Art

An image projection device using Digital Light Processing (DLP), in which the mosaic phenomenon in pixels, a problem in regular Liquid Crystal Display (LCD) imaging devices, is eliminated to improve the ability to reproduce original colors, is used widely in theaters, conference rooms, and projection TV's, etc. The image projection device can be divided into a Front Projection device and a Rear Projection device according to the projection method.

The Front Projection device adopts the method of projecting image signals from the front, and is generally used in theaters, conference rooms, etc. On the other hand, the Rear Projection device adopts the method of projecting image signals from the rear of the screen. The Rear Projection device is commonly used in the form of projection TV's. In particular, Rear Projection devices are used more often than Front Projection devices, because of its ability to display a relatively bright image even in a bright environment.

FIG. 1 is a perspective view illustrating a conventional image projection device, and FIG. 2 is a schematic drawing illustrating the pixel structure shown on a screen by a conventional image projection device.

As shown in FIG. 1, a conventional image projection device comprises a lamp 91, a condenser lens 93 which collimates and irradiates light emitted from the lamp 91, a color wheel 95 which separates the collimated white light into red (R), green (G), and blue (B) colors and illuminates ⅓ for every frame, a collimation lens 97 which irradiates parallel the light emitted from the color wheel 95 for each color, a Digital Micro-mirror panel (hereafter referred to as “DMD”) 99 which adjusts the reflection angle for each pixel of the light collimated from the collimation lens 97 for each color to form a picture, and a projection lens 98 which projects the light from the DMD to a large display of a screen S.

On the DMD 99 are formed numerous micro-mirrors (not shown), which are minute in size and are associated with a pixel structure on a silicon wafer, and these micro-mirrors convert the path of the incident light on/off by individually undergoing a highly rapid tilting motion according to the digital information provided to the DMD 99 by a controller. The pixels controlled individually by the DMD 99 are magnified through a projection lens 98 so that a large display picture is formed on the screen S.

As described above, since conventional image projection devices form a large display simply through the magnified projection of the small original picture, there is the problem that the picture quality is degraded due to the grid pattern formed between each pixel P, as seen in FIG. 2. Also, there is a problem in that when the picture moves rapidly or where the line of sight of the viewer moves rapidly, the picture is formed on the screen with rainbow colors showing where the contrast ratio is great, for example where there are black stripes on a white background, or with the grid pattern between each pixel notably significant.

### SUMMARY OF THE INVENTION

The invention provides a tilting device and an operation method thereof which provides a smooth and natural display by periodically tilting light reflected from a DMD in constant time intervals and reflecting it to a screen.

The invention provides a tilting device and an operation method thereof which may reduce the number of pixels for a DMD.

Additional aspects and advantages of the present general inventive concept will be set forth in part in the description which follows and, in part, will be obvious from the description, or may be learned by practice of the general inventive concept.

An aspect of the invention provides a tilting device comprising: a mirror positioned on a light path which periodically tilts light, a mirror holder joined to the mirror which vibrates with the mirror, a holder support part supporting the mirror holder to allow vibration, and a driving part which provides driving power to the mirror holder, wherein the driving part forms a predetermined angle with the mirror holder and causes vibration about the intersecting first axis and second axis.

Embodiments of the tilting device according to the invention may include the following features. For instance, the first axis and the second axis may form an angle of about 90°.

The driving part may comprise a first driving part positioned on the second axis and a second driving part positioned on the first axis, with the first driving part causing the mirror holder to vibrate about the first axis and the second driving part causing the mirror holder to vibrate about the second axis.

The first driving part and the second driving part may each have a coil joined to the reverse side of the mirror holder and a magnet surrounding the perimeter of the coil, and the coils may each be positioned on the first axis and the second axis.

The first driving part and the second driving part may further comprise yokes which are in contact with the magnets and which surround the perimeter of the coils. Also, the first driving part and the second driving part may further comprise cores which are in contact with the magnets and and of which a portion is positioned inside the coils.

Damping forces may be applied on the reverse side of the mirror holder at positions symmetrical to the coils with respect to the first axis and the second axis.

Dampers may be mounted on the reverse side of the mirror holder which are symmetrical to the coils with respect to the first axis and the second axis and on which damping forces are applied, the holder support part may comprise insertion grooves which hold the dampers and through which fluid is inserted, and damping of the dampers may be effected by means of a fluid. Such a fluid may be selected from a group consisting of grease, glycerin, UV-setting silicon, castor oil, SAE 30 oil, SAE 10W-30 oil, and SAE 10W oil.

The holder support part may support the mirror holder to allow vibration by means of a connection element. The connection element may be formed as a single body with the mirror holder and the holder support part. Also, the mirror holder and the holder support part may be formed with polyphenylene sulfide. The connection element may too be formed with polyphenylene sulfide.

The mirror holder may have a shape of a cross. The tilting device may further comprise a base holder, which secures the holder support part and has a housing groove that houses a portion of the driving part.

The holder support part may have a penetration hole adjoining the housing groove, and a portion of the coil may be positioned through the penetration hole, and inside the housing groove.

The mirror may be supported by the mirror holder via a securing element. Also, the mirror may be elastically supported by an elastic element positioned between the mirror holder and the mirror.

The mirror holder may have a securing protrusion on one side, and the elastic element may have a securing hole through which the securing protrusion may be inserted. The elastic element may be a flat spring.

Another aspect of the invention provides an operation method for a tilting device comprising: sending periodically a first signal to a first driving part in constant time intervals, and sending periodically a second signal to a second driving part in constant time intervals, wherein portions of the first signal and the second signal overlap.

Embodiments of the operation method for a tilting device according to the invention may include the following features.

For example, the first signal and the second signal may have the same magnitude. The first signal and the second signal may be pulse waves. The first signal and the second signal may have a T1 section during which signals are inputted and a T2 section during which signals are not inputted. The T1 section and the T2 section may have the same time duration. The overlap section during which the first signal and the second signal overlap may be approximately a half of the section during which the first signal or the second signal is sent. During the overlap section, the color wheel motor may undergo N rotations, or 1 rotation to be specific.

A further aspect of the invention provides a light engine module comprising: a digital micro-mirror chip disposed so that corners of micro-mirrors are adjacent, and a color wheel positioned between a light source and the digital micro-mirror chip, which separates the light emitted from the light source, wherein pixels generated by the micro-mirrors are tilted by a tilting device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram of a conventional image projection device.

FIG. 2 is a schematic diagram illustrating the pixel structure shown on a screen by a conventional image projection device.

FIG. 3 is an exploded perspective view of a tilting device according to an embodiment of the invention.

FIG. 4 is a perspective view of the tilting device of FIG. 3 after assembly.

FIG. 5 is a perspective view illustrating a tilting device according to an embodiment of the invention with coils joined to the reverse side of the mirror holder.

FIG. 6 is a bottom plan view of the mirror holder in a tilting device according to an embodiment of the invention.

FIG. 7 is a plan view of the holder support part in a tilting device according to an embodiment of the invention.

FIG. 8 is a plan view of the base holder in a tilting device according to an embodiment of the invention.

FIG. 9 is a cross sectional view of the tilting device illustrated in FIG. 4 across the AA′ line.

FIG. 10 is a graph illustrating a first signal S1 and a second signal S2 sent to a first driving part and a second driving part.

FIG. 11 is a schematic diagram illustrating the change in position of a pixel with the operation of the tilting device.

FIG. 12 is a schematic diagram illustrating the change in position of pixels with the operation of the tilting device.

FIG. 13 is a schematic diagram illustrating the arrangement of micro-mirrors in a conventional Digital Micro-mirror chip.

FIG. 14 is a schematic diagram illustrating the arrangement of micro-mirrors in a Digital Micro-mirror chip used in a light engine module according to the invention.

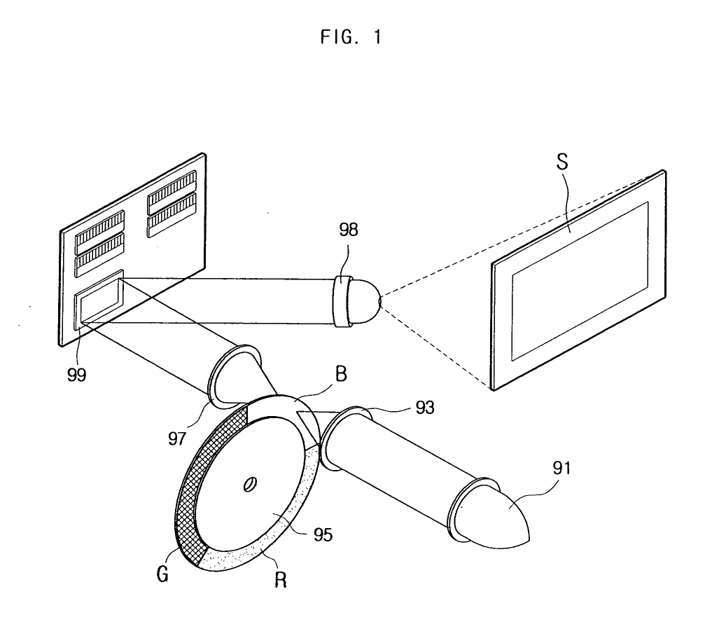

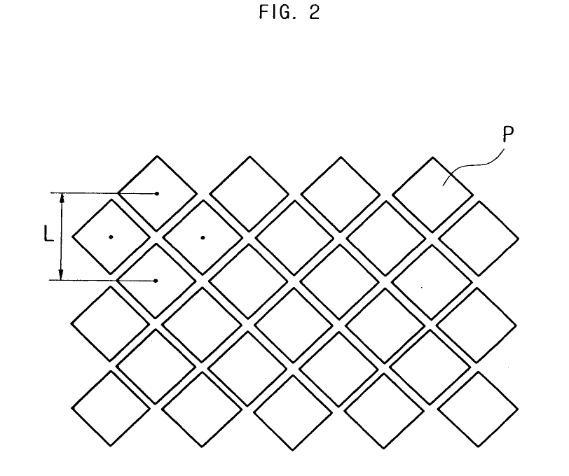

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

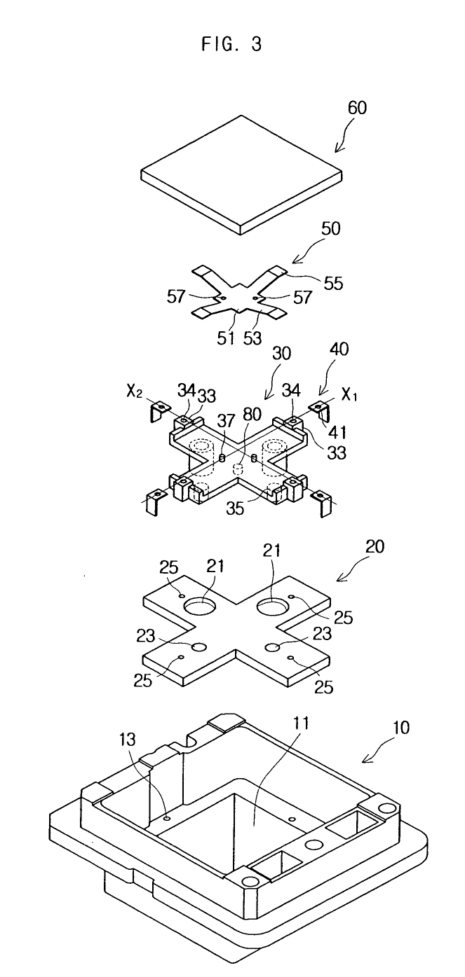

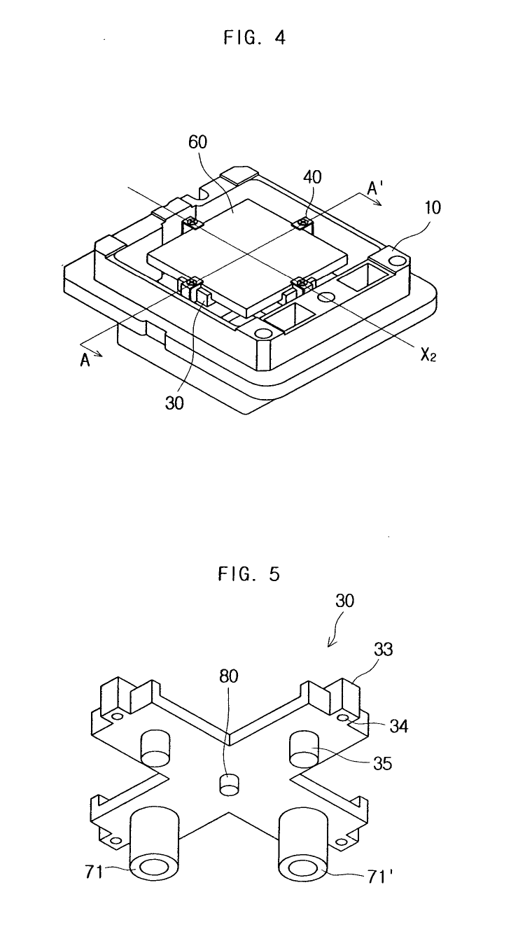

As seen in FIGS. 3 and 4, the tilting device according to an embodiment of the invention comprises a mirror 60 which reflects light, a mirror holder 30 which vibrates with the mirror 60, an elastic element 50 positioned between the mirror 60 and the mirror holder 30, a securing element 40 which secures the mirror 60 to the mirror holder 30, a holder support part 20 which supports the mirror holder 30 to allow vibration, and a base holder 10 which secures the holder support part 20. Although it is not shown in FIG. 3, the tilting device also comprises a driving part (see FIG. 9), which provides driving power to the mirror holder 30.

The mirror 60 is located on the light path and periodically tilts the light. The reverse side of the mirror 60 is elastically in contact with the contacting part 55 of the elastic element 50 (see FIG. 9), and the upper side is secured by the pressure applied by the securing element 40. Thus, the mirror 60 is firmly secured to the mirror holder 20 by means of the elastic element 50 and the securing element 40. The mirror 60, as seen in FIGS. 3 to 4, vibrates about a first axis X1 and a second axis X2 and tilts light emitted from a light source.

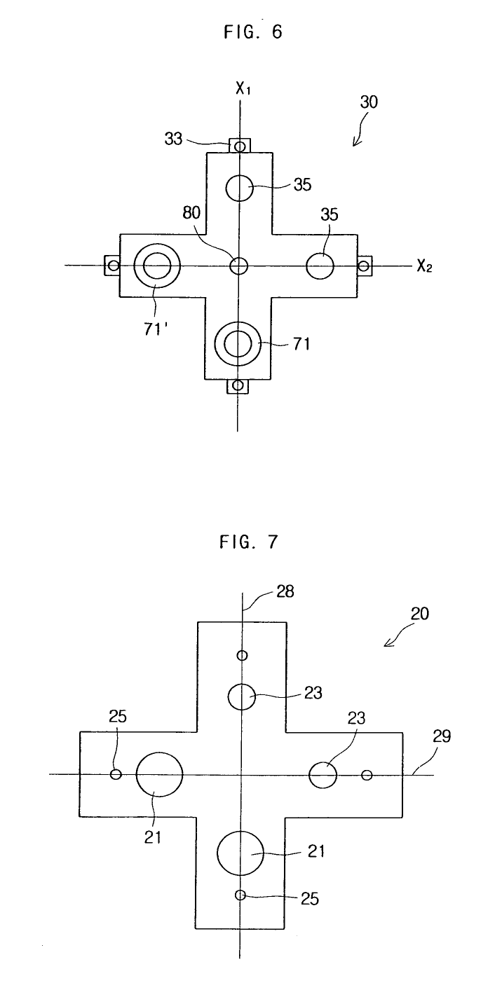

The first axis X1 and the second axis X2 may pass the center of gravity of the mirror 60 and may intersect at a predetermined angle, for instance approximately 90 degrees. The first axis X1 and the second axis X2, as shown in FIGS. 6 to 7, may pass the centers of gravity of the mirror holder 30 and the holder support part 20, respectively, which will further be discussed below.

The elastic element 50 is mounted on the upper side of the mirror holder 30 and elastically supports the reverse side of the mirror 60. The elastic element 50 has securing holes 57 on a diagonal line of its body 51, and into each securing hole 57 is inserted a securing protrusion 37 positioned on the upper side of the mirror holder 30. This prevents the detachment of the elastic element 50.

A sloped part 53 having a certain inclination angle and protruded upward is positioned on each side of the body 51 of the elastic element 50, and a contacting part 55 parallel to the body 51 is formed at the end of the sloped part 53. When the mirror 60 is secured to the mirror holder 30 by the securing element 40, the sloped parts 53 bend to a certain degree and elastically apply pressure to the mirror 60. The contacting parts 55 are in contact with the reverse side of the mirror 60, as seen in FIG. 9.

As illustrated in FIGS. 3 and 5, the mirror holder 30 of a tilting device according to an embodiment of the invention is joined to the mirror by the securing element 40 and vibrates with the mirror 60 about the first axis X1 and the second axis X2. The elastic element 50 is positioned between the mirror holder 30 and the mirror 60. The mirror holder 30 is connected to the holder support part 20 by means of a connection element 80 and may vibrate minutely due to the elastic force of the connection element 80. The shape of the mirror holder 30 is rendered a cross shape, so as to reduce overshooting and decrease rising time by decreasing the mass of the mirror holder 30 itself. Also, the mirror holder 30 may be formed with a strong yet light material, such as polyphenylene sulfide. The connection element 80 that connects the mirror holder 30 and the holder support part 20 may be formed as a portion of the mirror holder 30.

The mirror holder 30 comprises securing ledges in contact with the four sides of the mirror 60, respectively, mirror securing parts 33 protruding from the securing ledges and having fastening holes 34, and dampers 35 positioned on the reverse side of the mirror holder 30.

The securing ledges are protruded upward from one side of the mirror holder 30 and are in contact with the four sides of the mirror 60, respectively. The distance between securing ledges positioned on the first axis X1 and the second axis X2 may be equal to the parallel sides of the mirror 60, respectively. Obviously, the length of the securing ledge may be varied as needed.

The mirror securing part 33 is formed at the securing ledge and has a fastening hole 34 that joins with the securing element 40. The securing element 40 is mounted on the upper side of the mirror securing part 33 and secured with screws. The securing element 40 positioned on the mirror securing part 33 is in contact with the upper side of the mirror 60 and secures the mirror 60 to the mirror holder 30. The mirror securing parts 33 may be positioned on the first axis X1 and the second axis X2, respectively.

As illustrated in FIGS. 5 and 6, dampers 35 are positioned on the reverse side of the mirror holder 30. The dampers 35 are protruded downward in a cylindrical shape, and are each positioned on the first axis X1 and the second axis X2, which pass through the center of gravity of the mirror holder 30. When the mirror holder 30 vibrates about the first axis X1 and the second axis X2 due to the driving power operating on the reverse side of the mirror holder 30, the dampers 35 provide damping force to the mirror holder 30 at positions symmetrical to the points at which the driving power is operated. Thus, the dampers 35 are housed in fluid insertion grooves 23 of the holder support part 20 illustrated in FIG. 3, and damping of the vibration is effected by means of viscous fluid inserted into the fluid insertion grooves 23.

On the reverse side of the mirror holder 30, a first coil 71′ and a second coil 71 may be positioned on the second axis X2 and the first axis X1, respectively. Also, the first coil 71′ and the second coil 71 may be positioned to be symmetrical to the dampers with respect to the first axis X1 and the second axis X2, respectively. The first coil 71′ and the second coil 71 cause the mirror holder 30 and the mirror 60 to vibrate about the first axis X1 and the second axis X2, which will further be discussed below.

As illustrated in FIGS. 3 and 7, the holder support part 20 has a cross shape and supports the mirror holder 30 to allow vibration by the connection element 80. Like the mirror holder 30, the holder support part 20 may be formed with polyphenylene sulfide. The holder support part 20 is secured to the base holder 10. The holder support part 20, as seen in FIG. 7, comprises penetration holes 21, fluid insertion grooves 23, and fastening holes 25.

The penetration holes 21 are formed on the first axis X1 and the second axis X2, which pass the center of gravity of the holder support part 20, at positions eccentric to the center of gravity. The positions of the penetration holes 21 correspond with the positions of the first coil 71′ and the second coil 71 attached to the reverse side of the mirror holder 30 seen in FIG. 6. Therefore, as shown in FIG. 9, portions of the first coil 71′ and the second coil 71 may be positioned inside the penetration holes 21, and portions of a yoke 77 and a magnet 75, which consist a driving part, may also be positioned inside a penetration hole 21.

The fluid insertion grooves 23 are positioned to be symmetrical to the penetration holes 21 with respect to the first axis X1 and the second axis X2. As shown in FIG. 9, a portion of the damper 35 on the reverse side of the mirror holder 30 is positioned inside the fluid insertion groove 23, and viscous fluid 90 is injected. Therefore, when the mirror 60 and the mirror holder 30 vibrate about the first axis X1 and the second axis X2, the dampers 35 are vibrated within the fluid insertion grooves 23 at a minute angle, and thus damping force is applied on the dampers 35 due to the viscous fluid 90.

Any viscous fluid 90 may be used that can provide damping force on the dampers 35. A fluid that does not easily evaporate or leak is preferable. Examples of viscous fluid include grease, glycerin, UV-setting liquid silicon, castor oil, SAE 30 oil, SAE 10W-30 oil, and SAE 10W oil, etc.

For grease, a consistency of about 265 to 475 is preferable (as specified by the National Lubricating Grease Institute). For the base oil, silicon oil or PAO, etc. is preferable, of which the change in consistency is not great under high temperatures. For the thickener, lithium, silica gel, or PTFE (polytetrafluoroethylene, commonly known as “Teflon”), etc. may be used.

UV-setting silicon has a very high viscosity of 87,000 mPas (error range ±10,000) and is very stable, as there is virtually no change in viscosity in the temperature range of −40 to 80° C. Also, excellent damping may be effected with only a small amount.

Since the viscosity coefficient μ is 1.494 (kg/ms) at 20° C. for glycerin and μ≈1 for castor oil, sufficient damping forces may be transferred to the dampers 35.

Also, since SAE 30 oil, for which μ=0.43, SAE 10W-30 oil, for which μ=0.17, and SAE 10W oil, for which μ=0.1, have much higher viscosity coefficients compared to water (μ=0.001), damping forces may efficiently be transferred to the dampers 35.

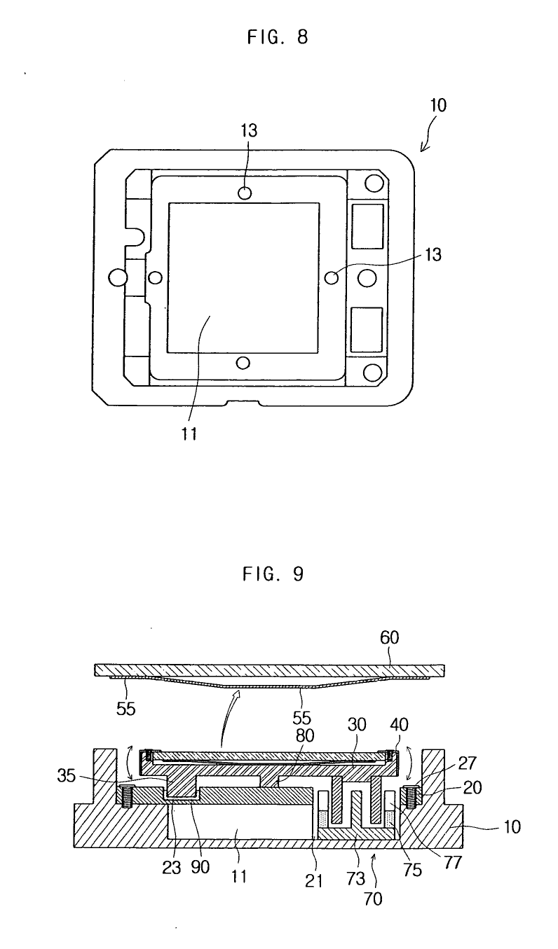

The holder support part 20 comprises fastening holes 25 formed on the first axis X1 and the second axis X2, respectively. The positions of the fastening holes 25 correspond with the positions of the fastening holes 13 on the base holder 10 (see FIG. 8). Screws 27 are applied at the fastening holes 25, as shown in FIG. 9, and thus the holder support part 20 is secured to the base holder 10.

As illustrated in FIGS. 3 and 8, the base holder 10 comprises a housing groove 11, which forms a space in the center, and fastening holes 13 formed around the perimeter part of the housing groove 11. The base holder 10 houses the driving part (not shown), and joins with the holder support part 20 by screws, etc. Also, a printed circuit board (not shown), etc., which supplies electric signals to the driving part may be attached to the base holder 10.

The housing groove 11 is a groove formed in the center of the base holder 10, of which the driving part (not shown) is positioned in the interior. That is, the core 73 is mounted in the housing groove 11, and the magnet 75 and yoke 77 are positioned at the upper part of the core 73, as is shown in FIG. 9.

As illustrated in FIG. 8, fastening holes 13 are formed around the upper part of the housing groove 11, the fastening holes 13 formed at positions corresponding with the fastening holes 25 formed on the holder support part 20. Hence, the holder support part 20 is secured by the screws 27 inserted through the fastening holes 25 of the holder support part 20 and the fastening holes 13 of the base holder 10, after it is mounted inside the base holder 10.

As illustrated in FIG. 9, the driving part 70 comprises the cores positioned in the housing groove 11 of the base holder 10, the magnets 75 positioned at the upper parts of the cores 73, the yokes 77, and the coils 71 attached to the reverse side of the mirror holder 30. The driving part 70 comprises a first driving part 70, positioned on the first axis X1 which causes the mirror 60 and the mirror holder 30 to vibrate about the second axis X2, and the second driving part 70′, positioned on the second axis X2 which causes the mirror 60 and the mirror holder 30 to vibrate about the first axis X1. FIG. 9 illustrates the first driving part 70 by a cross sectional view across line AA′ of FIG. 4, which is identical to a cross sectional view across the second axis X2. Since the first driving part 70 and the second driving part 70′ may consist of voice coil motors having identical configurations, only the first driving part 70 will be discussed below.

The coil 71 is a wound coil joined to the reverse side of the mirror holder 30 and creates an electric field when an electric signal is sent. As in FIG. 9, the coil 71 may be positioned to be perpendicular to the magnet 75. Also, as shown in FIG. 6, the coils 71, 71′ may be positioned on the first axis X1 and the second axis X2, respectively, on the reverse side of the mirror holder 30. Thus, the interaction between the electric field generated by the coil 71 and the magnetic field generated by the magnet 75 creates electromagnetic force, and consequently the mirror 60 and the mirror holder 30 may vibrate about the two axes, the first axis X1 and the second axis X2.

The magnet 75 is positioned on the core 73 and surrounds the coil 71. The magnet 75 magnetizes the yoke 77 and the core 73 and generates a magnetic field that passes through the coil 71.

The core 73 is magnetized by the magnet 75, and a portion is positioned inside the coil 71, as shown in FIG. 9. Also, the yoke 77 surrounds the coil 71 and is magnetized by the magnet 75. The core 73 and the yoke 77 concentrate the lines of magnetic force (not shown) generated by the magnet 75, thereby increasing the number of lines of magnetic force that pass through the coil 71. Therefore, the core 73 and the yoke 77 should preferably be of ferromagnetic material, such as nickel or iron.

Joining relationships within the tilting device will be discussed below with reference to FIGS. 3 and 9.

After the core 73, the magnet 75 and the yoke 77 are sequentially positioned in the housing groove 11 of the base holder 10, the core 73 is joined to the housing groove 11 by means of adhesives or screws, etc. Here, the first driving part 70 of the first axis X1 and the second driving part 70′ of the second axis X2 are both equally positioned in the housing groove 11.

The coil 71 is joined to the reverse side of the mirror holder 30 and is passed through the penetration hole 21 of the holder support part 20 to be positioned between the core 73 and the magnet 75 and yoke 77. When the mirror holder 30, the holder support part 20, and the connection element 80 are formed as a single body, the coil 71 is passed through the penetration hole 21 of the holder support part 20 and attached to the reverse side of the mirror holder 30. A suitable amount of viscous fluid is injected into the fastening hole 25.

The securing protrusion 37 of the mirror holder 30 is inserted in the securing hole 57 of the elastic element 50 and secured, after which the mirror 60 is positioned on the contacting part 55 of the elastic element 50. Then, the securing element 40 is screwed to the mirror securing part 33 of the mirror holder 30 so that the securing element 40 is in contact with the mirror 60 elastically supported by the elastic element 50.

After the holder support part 20, to which the mirror holder 30 is joined, is positioned on the base holder 10, the holder support part 20 is secured to the base holder 10 by applying screws at each fastening hole 13, 25. Also, a suitable amount of fluid 90 is injected into the fluid insertion groove 23 of the holder support part 20.

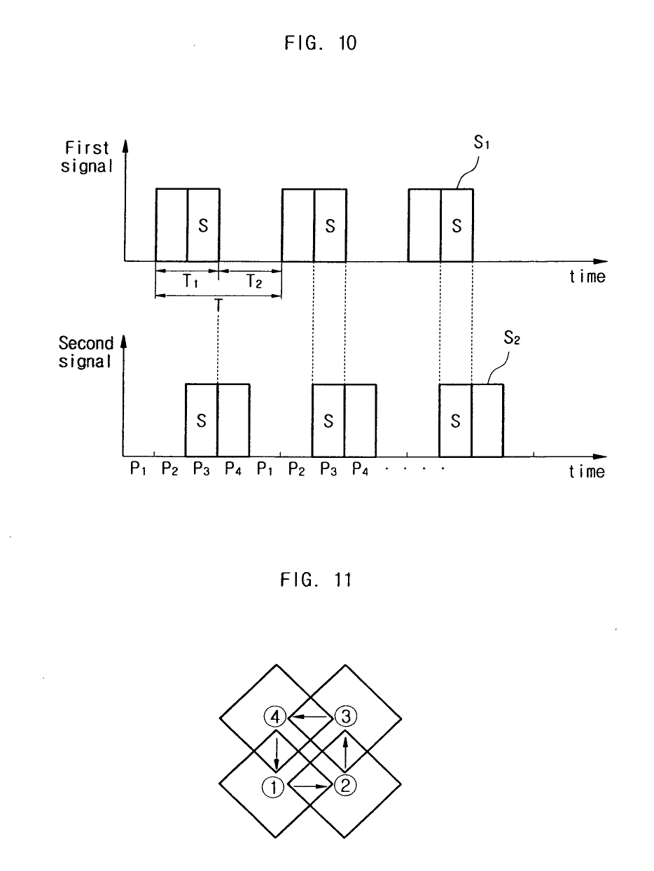

The operation of a tilting device according to an embodiment of the invention will be discussed below with reference to FIGS. 10 to 12.

Referring to FIG. 10, a first signal S1 and a second signal S2 having a constant time difference and different magnitudes are inputted to the first coil 71′ of the first driving part 70 and the second coil 71 of the second driving part 70. The first signal S1 and the second signal S2 may be pulse waves that are inputted in constant time intervals T, and have a section T1 during which signals are inputted and a section T2 during which electric signals are not inputted. Since the first signal S1 and the second signal S2 are inputted during the T1 section and not inputted during the T2 section, electric signals are inputted to the coils 71 to generate vibration in the mirror holder 30 and the mirror 60 during the T1 time period, and no vibration is generated during the T2 time period. Also, the first signal S1 and the second signal S2 may have an overlap section S, where the overlap section is approximately a half of the time T1 during which signals are inputted. In FIG. 10, the second signal S2 inputted to the second coil 71 is delayed by a time period of T1/2 compared to the first signal S1 inputted to the first coil 71′.

When the first signal S1 is inputted, the mirror holder 30 and the mirror 60 vibrate about the first axis X1 due to the interaction between the first coil 71′ (see FIG. 6) and the magnet (not shown) surrounding it. Here, the pixel reflected by the mirror 60 is moved from the first position P1 in FIG. 11 to the second position P2 for a period of T1. When the second signal S2 is inputted to the second coil 71, the mirror holder 30 and the mirror 60 vibrate about the second axis X2 due to the interaction between the second coil 71 and the magnet (not shown) surrounding it. Here, the pixel reflected by the mirror 60 is moved on the screen from the first position P1 in FIG. 11 to the fourth position P4 for a period of T1. Thus, the first signal S1 causes the mirror holder 30 and the mirror 60 to vibrate about the first axis X1, the second signal S2 causes vibration about the second axis X2, and the vibration time is T1.

Here, the first signal S1 and the second signal S2 have an overlap section S in which the signals overlap for a time period of T1/2, and during this overlapping period, the mirror holder 30 and the mirror 60 vibrate about the first axis X1 and the second axis X2 both. Therefore, the pixel formed on the screen appears on the third position P3 due to the overlapping of the second position P2 and the fourth position P4. Also, If neither the first signal S1 nor the second signal S2 are inputted to the first coil 71′ and the second coil 71, the pixel returns to its original position. Thus, the pixel is positioned sequentially at the first position P1, the second position P2, the third position P3, and the fourth position P4. If the first signal S1 and the second signal S2 are identical, T1 and T2 are identical, and the overlap section S is a half of the T1 section, the times during which the pixel stays at the first position P1, the second position P2, the third position P3, and the fourth position P4 are equal. The resulting pixels on the entire screen are as shown in FIG. 12.

As illustrated in FIG. 12, a pixel is positioned sequentially at \textcircled{1}, \textcircled{2}, \textcircled{3}, and \textcircled{4} due to the tilting device, and thus one pixel may display four pixels. Such a movement in pixel position occurs at a highly rapid speed of 60 Hz, so that the four pixels are perceived simultaneously due to a visual afterimage effect, and a more natural display may be provided.

As mentioned above, the times during which a pixel stays at the first position P1, the second position P2, the third position P3, and the fourth position P4 may all be equal, which are equal to the time during which a color wheel (not shown) undergoes N revolutions. This is because the color wheel must undergo at least 1 revolution to separate white light from a light source (not shown) into natural colors.

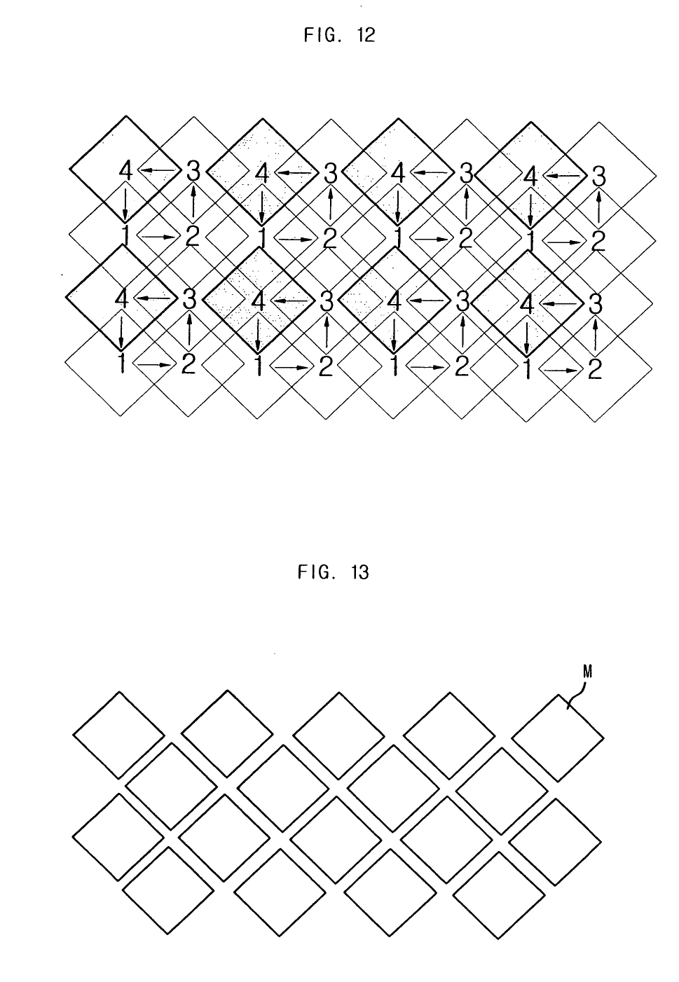

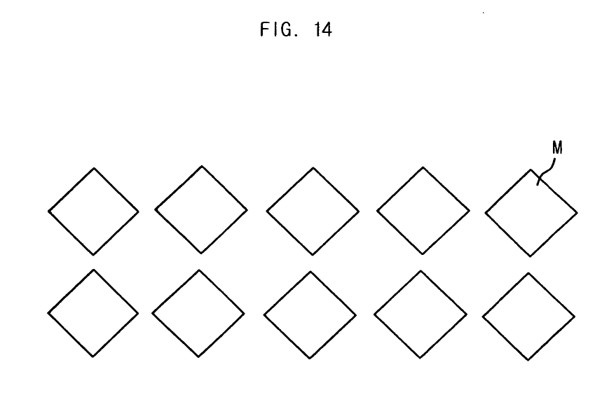

As illustrated in FIG. 13, the micro-mirrors M of a conventional DMD chip are arranged in the shape of an inclined chess board. One micro-mirror M reflects natural color light separated by the color wheel to the screen through a series of on/off operations. However, when using the tilting device according to embodiments of the invention, the number of micro-mirrors of a DMD chip may be reduced in half. That is, the micro-mirrors M may be arranged so that the corners are adjacent.

While the spirit of the invention has been described with reference to particular embodiments, it is to be appreciated that those skilled in the art can change or modify the embodiments without departing from the scope and spirit of the invention.

According to the invention, a tilting device and an operation method thereof may be provided which provides a smooth and natural display by periodically tilting light reflected from a DMD in constant time intervals and reflecting it to a screen.

The invention may also provide a tilting device and an operation method thereof which may reduce the number of pixels for a DMD.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A tilting device comprising:
a mirror positioned on a light path, which periodically tilts light;
a mirror holder joined to the mirror, which vibrates with the mirror;
a holder support part supporting the mirror holder to allow vibration; and
a driving part, which provides driving power to the mirror holder,
wherein the driving part forms a predetermined angle with the mirror holder and causes vibration about the intersecting first axis and second axis.

2. The tilting device of claim 1, wherein the first axis and the second axis forms an angle of about 90°.

3. The tilting device of claim 1, wherein the driving part comprises a first driving part positioned on the second axis and a second driving part positioned on the first axis, with the first driving part causing the mirror holder to vibrate about the first axis and the second driving part causing the mirror holder to vibrate about the second axis.

4. The tilting device of claim 3, wherein the first driving part and the second driving part each has a coil joined to the reverse side of the mirror holder and a magnet surrounding the perimeter of the coil, and the coils are each positioned on the first axis and the second axis.

5. The tilting device of claim 4, wherein the first driving part and the second driving part further comprise yokes which are in contact with the magnets and which surround the perimeter of the coils.

6. The tilting device of claim 5, wherein the first driving part and the second driving part further comprise cores which are in contact with the magnets and of which a portion is positioned inside the coils.

7. The tilting device of claim 4, wherein damping forces are applied on the reverse side of the mirror holder at positions symmetrical to the coils with respect to the first axis and the second axis.

8. The tilting device of claim 7, wherein dampers are mounted on the reverse side of the mirror holder which are symmetrical to the coils with respect to the first axis and the second axis and on which damping forces are applied,
the holder support part comprises insertion grooves which hold the dampers and through which fluid is inserted, and
damping of the dampers is effected by means of the fluid.

9. The tilting device of claim 8, wherein the fluid is selected from a group consisting of grease, glycerin, UV-setting silicon, castor oil, SAE 30 oil, SAE 10W-30 oil, and SAE 10W oil.

10. The tilting device of claim 1, wherein the holder support part supports the mirror holder to allow vibration by means of a connection element.

11. The tilting device of claim 10, wherein the connection element is formed as a single body with the mirror holder and the holder support part.

12. The tilting device of claim 1, wherein the mirror holder is formed with polyphenylene sulfide.

13. The tilting device of claim 1, wherein the holder support part is formed with polyphenylene sulfide.

14. The tilting device of claim 10, wherein the connection element is formed with polyphenylene sulfide.

15. The tilting device of claim 11, wherein the connection element is formed with polyphenylene sulfide.

16. The tilting device of claim 1, wherein the mirror holder has a shape of a cross.

17. The tilting device of claim 1, further comprising a base holder which secures the holder support part and has a housing groove that houses a portion of the driving part.

18. The tilting device of claim 17, wherein the holder support part has a penetration hole adjoining the housing groove, and a portion of the coil is positioned through the penetration hole and inside the housing groove.

19. The tilting device of claim 1, wherein the mirror is supported by the mirror holder via a securing element.

20. The tilting device of claim 19, wherein the mirror is elastically supported by an elastic element positioned between the mirror holder and the mirror.

21. The tilting device of claim 20, wherein the mirror holder has a securing protrusion on one side, and the elastic element has a securing hole through which the securing protrusion is inserted.

22. The tilting device of claim 20, wherein the elastic element is a flat spring.

23. The tilting device of claim 21, wherein the elastic element is a flat spring.

24. A method of operating a tilting device, comprising:
sending periodically a first signal to a first driving part in constant time intervals; and
sending periodically a second signal to a second driving part in constant time intervals;
wherein portions of the first signal and the second signal overlap.

25. The method of claim 24, wherein the first signal and the second signal have the same magnitude.

26. The method of claim 24, wherein the first signal and the second signal are pulse waves.

27. The method of claim 25, wherein the first signal and the second signal have a T1 section during which signals are inputted and a T2 section during which signals are not inputted.

28. The method of claim 27, wherein the T1 section and the T2 section are identical.

29. The method of claim 28, wherein an overlap section during which the first signal and the second signal overlap is approximately a half of the section during which the first signal or the second signal is sent.

30. The method of claim 29, wherein the color wheel motor undergoes N rotations during the overlap section.

31. The method of claim 30, wherein the color wheel motor undergoes 1 rotation during the overlap section.

32. A light engine module including the tilting device of claim 1, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

33. A light engine module including the tilting device of claim 2, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

34. A light engine module including the tilting device of claim 3, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

35. A light engine module including the tilting device of claim 4, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

36. A light engine module including the tilting device of claim 5, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

37. A light engine module including the tilting device of claim 6, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

38. A light engine module including the tilting device of claim 7, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

39. A light engine module including the tilting device of claim 8, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

40. A light engine module including the tilting device of claim 9, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

41. A light engine module including the tilting device of claim 10, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

42. A light engine module including the tilting device of claim 11, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

43. A light engine module including the tilting device of claim 12, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

44. A light engine module including the tilting device of claim 13, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

45. A light engine module including the tilting device of claim 14, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

46. A light engine module including the tilting device of claim 15, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

47. A light engine module including the tilting device of claim 16, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

48. A light engine module including the tilting device of claim 17, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

49. A light engine module including the tilting device of claim 18, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

50. A light engine module including the tilting device of claim 19, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

51. A light engine module including the tilting device of claim 20, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

52. A light engine module including the tilting device of claim 21, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

53. A light engine module including the tilting device of claim 22, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

54. A light engine module including the tilting device of claim 23, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.

55. A light engine module including the tilting device of claim 24, comprising:
a digital micro-mirror chip disposed so that corners of micro-mirrors are adjacent; and
a color wheel positioned between a light source and the digital micro-mirror chip, which separates the light emitted from the light source,
wherein pixels generated by the micro-mirrors are tilted by the tilting device.
